(19) United States
(12) Patent Application Publication
(10) Pub. No.: US 2024/0277019 A1
(43) Pub. Date: Aug. 22, 2024

(54) BEET PECTIN COMPOSITIONS

(71) Applicant: WHITEWAVE SERVICES, INC., Broomfield, CO (US)

(72) Inventor: Pulari Krishnankutty NAIR, Denver, CO (US)

(21) Appl. No.: 18/569,009

(22) PCT Filed: Jun. 10, 2022
(86) PCT No.: PCT/US2022/072860

§ 371 Date: Dec. 11, 2023

Related U.S. Application Data
(60) Provisional application No. 63/210,578, filed on Jun. 15, 2021.

(51) Int. Cl. A23L 29/231; A23L 11/00; A23L 29/10

(52) U.S. Cl. CPC A23L 29/231; A23L 11/05; A23L 29/10

(57) ABSTRACT

The invention describes the use of sugar beet pectin stabilized oil in water emulsions with plant based foods.

### CROSS REFERENCE TO RELATED APPLICATIONS

This application is a 371 of international application number PCT/US2022/072860, filed Jun. 10, 2022 and titled BEET PECTIN COMPOSITIONS and claims priority to U.S. Provisional Application No. 63/210,578, filed Jun. 15, 2021 and titled BEET PECTIN COMPOSITIONS, the entire contents of which are incorporated herein by reference.

### FIELD OF THE INVENTION

The invention relates generally to the use of beet pectin stabilized oil in water emulsions with plant based foods.

### BACKGROUND OF THE INVENTION

Plant based food products have become popular in recent years due to health consciousness, costs, and concerns regarding treatment of poultry, fish/crustaceans and livestock as well as the ecleaffects of agriculture in view of global warming from environmentally unfriendly practices.

However, many of the plant based food products require various additives, such as emulsifying agents, emulsion stabilizers and/or buffering agents to achieve suitable product characteristics desired by the consumer.

As consumers have become more health conscious with their dietary requirements, “clean labeling” has become important and the consumption of processed foods has become less desirable.

In general, clean labeling means making a food product with as few ingredients as possible, and making sure those ingredients are items that consumers recognize and think of as wholesome-ingredients that consumers might use at home. It seeks out foods with easy-to-recognize ingredients and no artificial ingredients or synthetic chemicals, and it has become associated with “trust” with manufacturers of food.

Clean labeling focuses on the use of simple natural ingredients without the need for various additives often found in processed foods. Clean labeling tries to avoid synthetic ingredients that are man-made, such as using real apple juice versus an ingredient made to taste like apple, highly processed ingredients and/or artificial ingredients, where several ingredients are combined and used to mimic a more desirable ingredient.

Therefore, a need exists that overcomes one or more of the current disadvantages noted above.

### BRIEF SUMMARY OF THE INVENTION

The present embodiments surprisingly provide the use of beet pectin as an emulsifier in food products that eliminates the need for incorporating other emulsifying agents, buffering agents and/or stabilizing agents in the food product. It has been advantageously found that beet pectin acts as an emulsifier and a stabilizer for the food product and is a food in and of itself. This helps lend to the inventiveness of the present embodiments as food products without the need of incorporation of processed materials, synthetic ingredients and/or artificial ingredients.

The embodiments described herein pertain to compositions that include a vegetable base; a vegetable oil or vegetable fat (vegetable also known as “vegetal”); sugar beet pectin; and water. The sugar beet pectin and the plant oil are emulsified in the water to provide a stable emulsion with the vegetable base. Use of the sugar beet pectin effectively eliminates the need for emulsifying agents, buffering agents and stabilizers, however, one or more of the agents can be included if the ultimate food product requires the agent for quality purposes.

In one aspect, the embodiments described herein pertain to compositions that include, for example, 40-95% w/w water; 0.001-40% w/w of a vegetable oil or vegetable fat; 0.001-2% sugar beet pectin, and a least one or more of: 00.01-2% plant proteins, 0-7% w/w a nut base composition, 0-35% w/w a sweeting agent, 0.0001%-5% w/w a buffering agent, and/or 0.0001% to 5% w/w a flavor modification agent, wherein the particle size particle size distribution of the composition has a surface weighted mean diameter D [3,2] of 10 μm or less

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 represents the particle size distribution of a coffee creamer using sugar beet pectin as an emulsifier-stabilizer system described in Example 1.

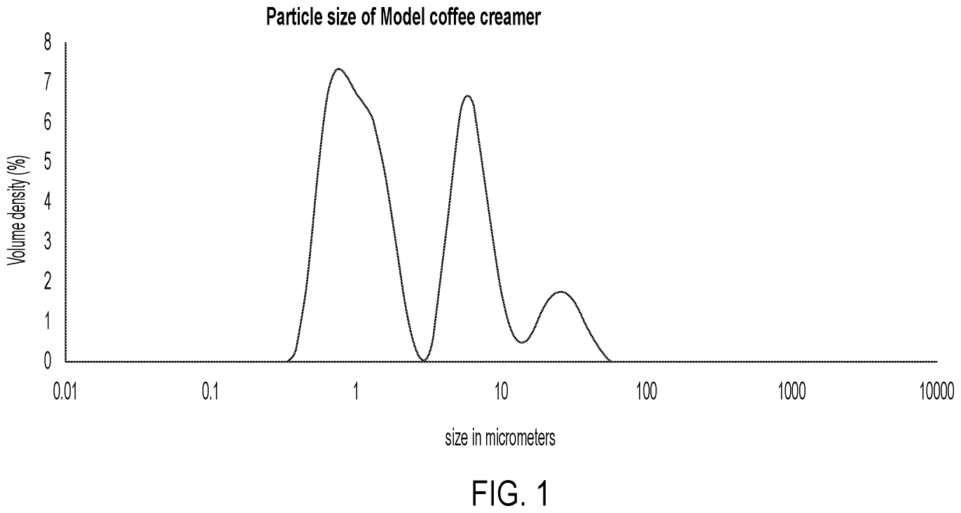

FIG. 2 represents the viscosity of a coffee creamer of Example 1 as compared against a commercial plant based coffee creamer.

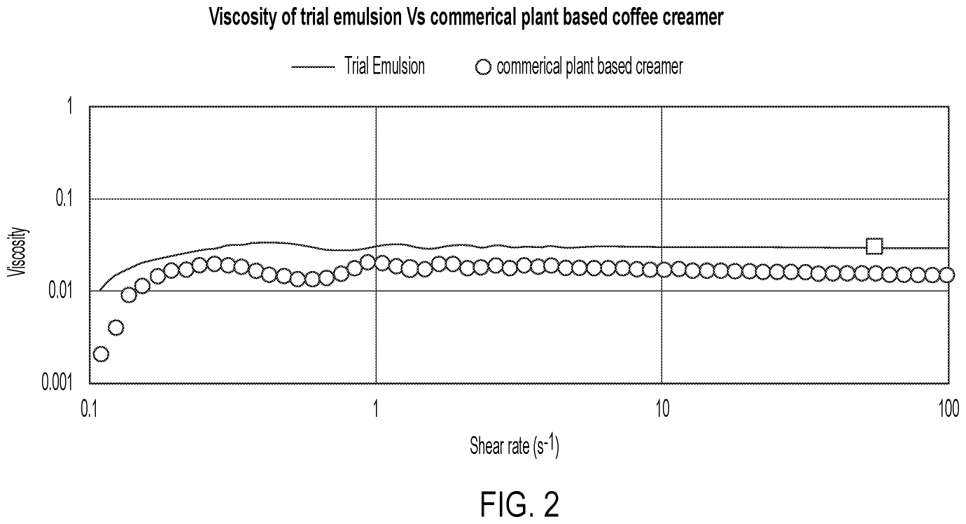

FIG. 3 provides viscosity data regarding Example 2.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

As used herein, the term “ppm” shall be taken to mean “parts per million”. One gram in 1 liter is 1000 ppm and one thousandth of a gram (0.001 g) in 1 liter is one ppm.

As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

In the context of this application, unless otherwise provided, amounts refer to amounts by weight.

As used herein the term “vegetable” shall be taken to mean edible parts of a plant including but not limited to vegetables, fruits, flowers, stems, seeds, leaves and roots.

As used herein the term “plant-based” shall be taken to mean a composition or product which comprises vegetable, plant or plant-derived matter but does not comprise animal or animal-derived matter including but not limited to dairy, egg, fish, shellfish, meat, dairy milk and insects.

As used herein the adjective “dairy” shall be taken to mean a composition or product comprises or consists of mammalian milk matter, i.e. the lacteal secretion obtainable by milking.

As used herein the terms “free” or “free from” shall be taken to mean a composition or product which preferably does not contain a given substance but where trace amounts or contaminants thereof may be present.

As used herein the terms plant-based alternative, analogue or substitute shall be taken to mean a plant-based food or beverage composition that is formulated to simulate the organoleptic and/or nutritional qualities of an equivalent non-plant-based product.

Plant-Based Sugar Beet Pectin Emulsions for use as Multifunctional Emulsifier and Stabilizer System for Food Products

In a first aspect, the present embodiments provide plant based liquid emulsions that are stable.

Accordingly, embodiments described herein provide compositions comprising a a) vegetable base; b) a vegetable oil or vegetable fat; c) a sugar beet pectin; and water, wherein the sugar beet pectin and the plant oil are emulsified to provide a stable emulsion.

The compositions described herein may optionally further comprise hydrocolloid agent(s), sweetening ingredients and/or flavor modification agents.

In the embodiments described herein, the stable compositions are oil in water emulsions.

In one embodiment, the stable compositions described herein are substantially free of a hydrocolloid, such as a gum. In another embodiment, the stable compositions described herein are free of a hydrocolloid, such as a gum. Should the composition comprise a minor amount of a hydrocolloid, this amount is less than 0.1% by weight, for example, less than 0.05%, for example, less than 0.01%, for example, less than 0.005%, for example, less than 0.001%.

The stable compositions described herein can, optionally, include at least one hydrocolloid agent. Suitable examples include, but are not limited to, hydrocolloids, including xanthan gum, tragacanth, gum arabic, acacia gum or gellan gum. Such compounds are known in the art and are commercially available. Gellan gum can be, for example, a high acyl gellan.

Commercially, gellan gum is manufactured by inoculating a fermentation medium that contains a carbon source, such as glucose, phosphate and nitrogen sources, and appropriate trace elements with the micro-organism. After fermentation, the viscous broth is pasteurized and the direct recovery of polysaccharide by alcohol precipitation yields the substituted, high acyl content gellan gum. While low acylated gellan gum is obtained after treating the broth with alkali and then with alcohol precipitation. The degree of acylation is over 50% for high acyl form with two acyl substituents acetate at C6 and glycerate at C2 on the first glucose unit of the repeating unit of tetra saccharide, and on average, there is one glycerate per repeat and one acetate per every two repeats, while low acylated gellan gum is partly deacylated.

In certain embodiments the composition comprises a single hydrocolloid agent.

In one embodiment, the optional hydrocolloid is present in an amount of from 0.0001% to 1% by weight, for example, from 0.01% to 0.01%.

In one embodiment, the stable compositions described herein are substantially free of and do not require the use of an emulsifying agent, such as mono- and diglycerides, polysorbates, carrageenan, guar gum and canola oil. Suitable lecithins, include but are not limited to, soy lecithin, sunflower lecithin, or rapeseed lecithin. In another embodiment, the stable compositions described herein are free of a lecithin. Should the composition comprise a minor amount of lecithin, this amount is less than 0.1% by weight, for example, less than 0.05%, for example, less than 0.01%, for example, less than 0.005%, for example, less than 0.001%.

In certain embodiments, the stable compositions described herein are free of guar gum. Should the composition comprise a minor amount of guar gum, this amount is less than 0.1% by weight, for example, less than 0.05%, for example, less than 0.01%, for example, less than 0.005%, for example, less than 0.001%.

It has been advantageously discovered that the sugar beet pectin acts as an emulsifying agent for the compositions described herein, thereby reducing or eliminating the need for more traditional emulsification agents.

Consumers are looking for more plant-based food products with minimal ingredients for various reasons like personal health, life style, ethics, and sustainability. It is believed that removal of emulsifiers, such as lecithins, leads to reduced emulsion stability, which negatively affects overall composition stability, and/or organoleptic properties. The functional attributes of lecithins are attributed to their low molecular weight and high hydrophilic lipophilic balance that makes it a very functional at the oil-water interface. Therefore, it is surprising and advantageous that the compositions described herein are stable without the need of significant levels of emulsifying agents, such as lecithin(s), to provide stability as required with food product compositions that are currently available. The compositions described herein can be refrigerated and/or are shelf-stable at ambient conditions.

In one embodiment, the stable compositions described herein are substantially free of a buffering agent, such as a monophosphate, diphosphate, bicarbonate, carbonates and the like. In another embodiment, the stable compositions described herein are free of a buffering agent(s). Should the composition comprise a minor amount of a buffering agent, this amount is less than 0.1% by weight, for example, less than 0.05%, for example, less than 0.01%, for example, less than 0.005%, for example, less than 0.001%.

As an exemplary embodiment, the stable compositions described herein are substantially free of dipotassium phosphate. Increasing consumer demand for food and beverage products containing natural ingredients is a major trend in the food industry. There is a demand for “clean-label foods” without adding ingredients that sounds like “chemical”. For this reason, many food research is concentrated on investigating commercially viable natural ingredients that have similar or better functional attributes than synthetic ones like dipotassium phosphate. In one embodiment, the stable compositions described herein are free of dipotassium phosphate. Should the composition comprise a minor amount of dipotassium phosphate this amount is less than 0.1% by weight, for example, less than 0.05%, for example, less than 0.01%, for example, less than 0.005%, for example, less than 0.001%.

Consumers are increasingly demanding label-friendly products prepared with natural and sustainable ingredients, which has stimulated interest in replacing synthetic surfactants. Biopolymer-based emulsifiers, such as amphiphilic proteins and polysaccharides, are particularly promising natural candidates to form and stabilize emulsions in food and other applications. Protein-based emulsifiers are already commonly used in industrial applications due to their good emulsifying ability. Nevertheless, there are important limitations to using protein-based emulsifiers in many food products, for example, protein-coated oil droplets are usually unstable at pH values around their isoelectric point, at high ionic strengths, and at elevated temperatures.

Not to be limited by theory, it is believed that the beet pectin-layer formed around the oil droplets provides electrostatic and steric repulsion, which helps to prevent droplets from flocculation and coalescence. Advantageously and surprisingly, this recognition was discovered by the inventors and has been applied to formulations/compositions described herein.

The stable compositions are typically in the form of an emulsion of vegetable oil or vegetable fat droplets in an aqueous phase. The stable compositions described herein have a uniform distribution of particles within the aqueous phase, during shelf-life, for example during up to 30, 60 or 90, 120, 150, 180, 210 or 240 days storage at ambient (“room”) temperature, for example, from 15° C. to 25° C.

The stable compositions described herein have a surface weight mean diameter of D [3,2] of about 1.18 microns (μm).

Advantageously, the composition particle size is maintained during shelf-life, for example, during up to 30, 60 or 90, 120, 150, 180, 210 or 240 days storage at ambient (“room”) temperature, for example, from 15° C. to 25° C.

In one embodiment the pH of the composition is at most 5.5, for example, from 4.5 to 8 or from 5 to 7.

### Water

The stable compositions disclosed herein comprise water. Water is typically present in an amount balancing the amounts of other ingredients to 100% by weight. In an embodiment water is present in an amount between 40% and 90% by weight, for example, or from 60% to 90%, or from 40% to 45% or from 45% to 50% or from 50% to 55% or from 55% to 60% or from 60% to 65% or from 65% to 70% or from 70% to 75%, or from 75% to 80% or from 80% to 85% or from 80% to 85%. In one embodiment the water quality is monitored to ensure a sufficiently low level of cations to ensure emulsification stability is not impacted. The total cation content can be from about 60 ppm (40 ppm for divalent ions and 20 ppm for monovalent ions) and the hardness of water can be 6 gram/gallon or less.

### Vegetable Base

The term “vegetable base” is intended to include an aqueous suspension comprising water and plant-matter selected from the group consisting of legumes, nuts, seeds, cereals and/or combination thereof. In one aspect, the vegetable base is a base free from, or does not comprise, added sugar, where the total carbohydrate content of the vegetable base is derived from plant-matter selected from the group consisting of legumes, nuts, seeds, cereals and/or combination thereof.

In some embodiments, the plant-matter comprises plant protein sources such as legumes, including pulse or pulses. In other embodiments, the pulses are selected from the group consisting of split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy, faba and/or lupin.

In other embodiments, the plant-matter comprises plant protein sources from tubers or cereals such as potato, rice and/or wheat.

In other embodiments, the nuts are selected from the group consisting of almonds, cashews, pecans, macadamias, hazelnuts, pistachio, walnuts or combinations thereof.

In still other embodiments, the seeds are selected from the group consisting of hemp, pumpkin, quinoa, sesame, tiger nut, flax, chia, sunflower, coconut or combinations thereof.

In yet other embodiments, said cereals are selected from the group consisting of wheat, rye, spelt, barley, oat, millet, sorghum, rice, teff and combinations thereof.

Processes for the preparation of such suspensions are known in the art and typically comprise mechanical and/or enzymatic disruption of the plant-matter and hydration and/or combination with a solution, followed by mechanical separation of an aqueous fraction from starchy and/or fibrous matter, e.g., by decanting, centrifugation or filtration. For example, the plant-matter may be milled, ground, soaked, dehulled, and mixed with water, optionally enzymatic hydrolysed and/or homogenized etc. in order to produce a suitable aqueous composition.

In other embodiments, the plant matter may be a seed or nut butter such as sunflower, sesame, soy, almond, cashew, hazelnut or peanut butter. Processes for the preparation of nut butters typically comprise wet or dry grinding roasted or unroasted nuts to a paste having a particle size suitable for the preparation of nut beverages.

In still other embodiments, the plant matter may be a hydrolyzed cereal suspension such as an oat milk or syrup. Processes for the preparation of such cereal suspensions typically comprise mixing an oat material (such as rolled oats, milled oats, oat flour or oatmeal) with water and treated enzymatically by amylases to hydrolyze starch followed by removal of suspended matter.

In some embodiments, the vegetable base may comprise plant protein ingredients. Plant protein ingredients are known in the art and are commercially available. Plant protein ingredients can be, for example, a plant protein isolate, concentrate or flour.

The term “protein concentrate,” as used herein, generally refers to protein derived from plant source that has been extracted from the plant source and purified. Protein concentrate may comprise greater than or equal to about 40%, 50%, 60%, 70%, or 80%, or more total protein on a dry matter basis. The protein concentration of the protein concentrate may be increased by greater than or equal to about 20%, 30%, 40%, 50%, 60%, 70%, 80%, or more than the protein concentration of the plant. A protein concentrate may comprise a single type of protein or a combination of different types of proteins.

The term “protein isolate,” as used herein, generally refers to protein derived from a plant source that has been extracted from the plant source and purified. A protein isolate may have a higher purity than a protein concentrate. A protein isolate may be formed by further processing a protein concentrate to increase the protein concentration. Protein isolate may comprise greater than or equal to about 80%, 90%, 95%, or more protein on a dry matter basis.

In certain embodiments, the plant protein has not been subjected to a hydrolysis step.

### Vegetable Oil or Vegetable Fat

The stable compositions disclosed herein comprises at least one vegetable oil. Suitable examples of such oils include, but are not limited to, coconut oil, canola oil, soybean oil, sunflower oil, safflower oil, palm oil, palm kernel oil, olive oil, avocado oil and/or mixtures or combinations thereof. In certain embodiments, the oils are selected from the group consisting of coconut oil, palm oil, palm kernel oil, and/or mixtures or combinations thereof.

It should be understood that the term vegetable oil includes vegetable fats which can be a solid at room temperature whereas oils are liquids. Both types of compositions are included in this specification as both types of triglycerides are contemplated herein.

In one embodiment the vegetable oil or vegetable fat is present in an amount of from 0.01% to about 40 percent by weight or between 0.1% to 15 percent by weight, for example between 1 to 10%, or from 0.5% to 10%, or from 1% to 8%, or from 2% to 7%, or from 3% to 6%. Compositions with such amounts of vegetable oil or vegetable fat present good organoleptic properties.

### Beet Pectin

Pectin is commonly used for its gelling (as in jams, jellies, and marmalades), thickening, and stabilizing properties (in acidic beverages). It is commonly derived from citrus peel (lemon, grapefruit, lime, orange and so on), apple pomace in most cases and in some instances from sugar beet pulp as a byproduct during the extraction of sugar. Structurally pectin derived from citrus and apple pomace is different from that of sugar beet one. Pectin consists of a backbone consisting of α(1-4)-linked D-galacturonic acid units interrupted by the insertion of (1-2)-linked L-rhamnopyranosyl residue in adjacent or alternate positions; whereas the side chains consist mainly of D-galactose and L-arabinose linked glycosidically to 04 and/or 03 of the L-rhamnopyranose. Sugar beet pectin differs from other pectins in that it contains a high content of rich hairy regions consisting of neutral-sugars, higher content of acetic acid (14-26%) at C2 and C3 positions within the galacturonic acid residues and also phenolic esters in the side chains, especially arabinose and galactose and high content of the proteinaceous materials bound to the side chains. Sugar beet pectin contains significantly higher content of protein (10.4%) compared to apple (1.6%) and citrus (3-3.3%), respectively. Unlike regular pectins, sugar beet pectin (SBP) does not form gels when heated in acidic environment (pH 3-4) in the presence of high concentration of soluble solids (e.g., sugar).

The molecular weight of SBP used herein was at least 50 KDa.

Suitable sources of pectin include various beets such as, but not limited to, Avalanche, Bull's Blood, Chioggia, Crosby Egyptian, Cylindra, Detroit Dark Red, Early Wonder, Forono, Golden, Golden Detroit, Lutz Green Leaf, Merlin, Moulin Rouge, Red Ace, Red Ball, Ruby Queen, Touchstone Gold, White Detroit and Sugar beets.

Sugar beets are known as the Altissima cultivar group of the common beet (Beta vulgaris) and it belongs to the subspecies Beta vulgaris subsp. Vulgaris. A close wild relative is the sea beet, Beta vulgaris subsp. maritima.

Suitable ranges of sugar beet pectin to form an emulsion with water and a vegetable oil or vegetable fat are from 0.01 weight percent to about 40 percent by weight, or from about 0.1 weight percent to 15 weight percent, or from about 0.5 weight percent to about 10 weight percent or from about 1 weight percent to about 10 weight percent, or from about 2 weight percent to about 9 weight percent or from about 3 weight percent to about 7 weight percent or from about 3 weight percent to about weight percent.

### Buffering Agents

The stable compositions described herein can, optionally, comprise at least one buffering agent. Examples of such buffering agents include monophosphates, diphosphates, sodium mono- and bicarbonates, potassium mono- and bicarbonates, for example, potassium phosphate, dipotassium phosphate, potassium polyphosphates, sodium bicarbonate, trisodium citrate (also referred to as sodium citrate), sodium phosphate, disodium phosphate, trisodium phosphate and sodium polyphosphates, sodium bicarbonate, calcium carbonate and/or mixtures or combinations thereof.

The buffering agent can be provided in an amount sufficient to provide the pH of the composition of at most 9.5, for example, from 7 to 9.5 or from 8.5 to 9.5. Advantageously, the use of a buffering agent can contribute to product stability without impacting organoleptic properties and consumer perception. In one embodiment the buffering agent is present in an amount of from 0.0001% to 5% by weight, for example, from 0.2% to 1%.

### Sweetening Ingredients

The stable compositions disclosed herein can, optionally, comprise at least one sweetening ingredient. Such an ingredient can contribute to the consumer perceived sweetness properties of the composition. It can also provide bulking properties to the composition. The sugar ingredient can be, for example, but not limited to, sucrose, fructose, saccharose, glucose, maltodextrin, dextrose, sorbitol, xylitol, or a mixture thereof. In one embodiment, the sweetener is a corn syrup, for example, a high fructose corn syrup, a corn syrup solid, cane sugar, beetroot sugar, honey, agave, maple syrup, guava, cyclamates and salts thereof, sucralose, aspartame, saccharin and salts thereof, stevia, stevia components such as rebaudioside(s), rebaudioside A, xylitol, acesulfame-K, neotame, N--[N-[3-(3-hydroxy-4-methoxyphenyl)propyl]-alpha-aspartyI]-L-phenylalanine 1-methyl ester (hereinafter abbreviated as “ANS9801”), glycyrrhizin, thaumatin, monellin and the like, or a mixture thereof. In another embodiment, it is a mixture of at least two of sucrose, fructose, saccharose, glucose, maltodextrin, dextrose, sorbitol, xylitol, a corn syrup, for example, a high fructose corn syrup, a corn syrup solid, cane sugar, beetroot sugar, honey, agave, maple syrup guava, cyclamates and salts thereof, sucralose, aspartame, saccharin and salts thereof, stevia, stevia components such as rebaudioside(s), rebaudioside A, xylitol, acesulfame-K, neotame, N--[N-[3-(3-hydroxy-4-methoxyphenyl)propyl]-alpha-aspartyI]-L-phenylalanine 1-methyl ester (hereinafter abbreviated as “ANS9801”), glycyrrhizin, thaumatin, monellin and the like.

In one embodiment the sweetening ingredient is present in an amount of from 15% to 35% by weight. For example, the amount is from 15% to 20%, or from 20% to 25%, or from 25% to 30%, or from 25% to 30%, or from 30% to 35%.

### Optional Flavor Modification Agents

The stable compositions described herein, can optionally, include flavor modification agent(s), different from the sweetening ingredient. These typically affect the taste of the composition, the amount thereof is usually determined according to taste that is desired. Examples can include salts, sweeteners, flavors, flavor modifiers, fruits and/or fruit extracts. Popular flavor modification agents, for example, include vanilla flavor or extract, dairy artificial flavor, hazelnut artificial flavor, amaretto, cinnamon, chocolate, caramel. Suitable ranges for an optional flavor modification agent are from 0.0001% to 5% w/w, e.g., from 0.05% to 3%, from 0.1% to 2%, etc. Examples of salts include sodium chloride, for example, sea salt. Sea salt can be added from 0.0001 to 2.5%, e.g., 0.05%.

### Packaging

The stable compositions described herein are typically packaged in a container. The container is then typically sealed, for example, with a cap and/or a flexible lid. The container can, for example, have a holding capacity or volume of up to 2 kg or 2 L, for example, up to 1.5 kg or 1.5 L, for example, up to 1.0 kg or 1.0 L, for example, up to 500 g or 500 mL, for example, up to 250 g or 250 mL, for example, up to 125 g or 125 mL, for example, up to 100 g or 100 mL, for example, up to 50 g or 50 mL, for example, up to 25 g or 25 mL. The container might provide one or several servings. Containers of up 250 g or 250 mL, preferably up to 100 g or 100 mL, typically provide a single serving. The container can be a bottle or a cup, for example, a plastic thermoformed cup. The sealing can be provided by a flexible lid and/or or a plastic cap. The flexible lid can be, for example, thermosealed to or on the opening of the bottle or cup. The container can be a small single cup, for example, of from 5 g or 5 mL to 15 g or 15 mL, and, for example, sealed with a flexible lid. Such small single cups can be offered alone or grouped in a secondary packaging.

The stable compositions described herein in the container can be stored, transported and/or distributed at a chilled temperature of 0° C. to 10° C., or at ambient (“room”) temperature, for example, from 15° C. to 25° C.

In various embodiments disclosed herein, the compositions are free from additional additives selected from the group consisting of modified starches, hydrocolloids, emulsifiers, stabilizers and/or combinations or mixtures thereof.

Process for the Preparation of Plant-Based Beet Pectin Emulsions for use as a Multifunctional Emulsifier and Stabilizer System for Food Products

In a one aspect, the present embodiments provide processes for the preparation of plant based sugar beet pectin emulsions for use as a multifunctional emulsifier and stabilizer system for food products.

Processes for preparing plant-based sugar beet pectin emulsions for use as a multifunctional emulsifier and stabilizer system for food products comprise the steps:
i) providing an aqueous mixture comprising components vegetable oil or vegetable fat, sugar beet pectin and water, and one or more of a vegetable base, a hydrocolloid, an emulsifying agent, a buffering agent, a sweetening ingredient and/or a flavour modification agent;
ii) emulsifying the aqueous mixture;
iii) heating the aqueous mixture;
iv) emulsifying the heat treated aqueous mixture to provide a liquid composition; and
v) optionally packaging the liquid heat treated and emulsified composition.

The heat treatment iii), can be carried out by pasteurization, sterilization and/or ultra-high temperature treatments (UHT). UHT treatment is a process for preserving liquid beverages by exposing it to a brief, intense heating, normally to temperatures in the range of 135-145° C. for few seconds. This kills micro-organisms which would otherwise destroy the products. UHT treatment is a continuous process which takes place in a closed system. The product passes through heating and cooling stages. UHT processing can be used in conjunction with aseptic filling, to avoid re-contamination of with microbes.

Two common methods of UHT treatment are commonly used: (1) Indirect heating and cooling in heat exchangers, (2) Direct heating by steam injection or infusion of milk into steam and cooling by expansion under vacuum.

In certain aspects, the heat treatment iii) is under UHT and is carried out for less than 20 seconds and the mixture is heated to a final temperature of at least 140° C.

The emulsification can be carried out by means of homogenization. The homogenization can be a single step homogenization or a double step homogenization. The homogenization pressure may be adjusted to provide a stable composition having a uniform particle size distribution of a surface weighted mean diameter of D [3,2] of 10 microns or less. A suitable particle range size is from about 0.2 microns to 10 microns, for example 0.5 microns to 9 microns, for example, 1 micron to 8 microns, for example, 2 microns to 7 microns, and for example 3 microns to 5 microns.

The process can optionally comprises a step for the packaging of the liquid compositions described herein. The packaging can involve a step of dosing the composition in a container, and then sealing, for example, according to aseptic processing or Extended Shelf Life processing.

### Process of Use

The stable compositions described herein can be used in a process of making stable oil in water emulsions that can provide stability to plant based milks, plant based beverages, yogurts, plant based high fat products like creamers, light creams, heavy creams, whipping creams, ready-to-drink coffee, salad dressing, cooking creams, sauces, yogurts and so on. Oil in water emulsions are building blocks for these food systems and provide a stable food system to deliver fat without affecting the stability and appearance of food. The process typically comprises the step of mixing the stable compositions described herein with a food product. Upon mixing, the composition disperses in the food product, thereby modifying its taste and/or mouth feel, and/or other organoleptic properties of the food.

For example, a beverage can be a coffee, tea, chocolate or fruit beverage. Such beverages comprise corresponding components, extracts and/or flavors.

In one embodiment the beverage is a hot beverage. The stable composition is typically mixed into the hot beverage at chilled temperature or at ambient temperature.

In another embodiment, the beverage can be a carbonated or a fruit beverage, such as a soda or a fruit juice.

In yet another embodiment, the food product can be a “shake”, that is an ice cream, frozen yogurt or custard based beverage to which the compositions described herein can be added.

In one embodiment, at least 2 parts by weight, for example, at least 3 parts, for example, at least 4 parts, for example, at least 5 parts, of the beverage are mixed with 1 part by weight of the composition. In another embodiment, the container is a single serve container and all or part of the stable composition of the container is mixed with the beverage.

Organoleptic properties are intended to include sensory properties of a given composition such as, but not limited to, mouthfeel, texture, taste, smell, visual appearance, consistency of the product and physical attributes of a substance that are considered pleasing to the individual.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The following paragraphs enumerated consecutively from 1 through 18 provide for various aspects of the present embodiments. In one embodiment, in a first paragraph (1), the present embodiment provides a composition comprising: 40-95% w/w water; 0.001-40% w/w of a vegetable oil or vegetable fat; 0.001-2% sugar beet pectin; and at least one or more of: 00.01-2% plant proteins; 0-7% w/w a nut base composition; 0-35% w/w a sweeting agent; 0.0001%-5% w/w a buffering agent; and/or 0.0001% to 5% w/w a flavor modification agent, wherein the particle size particle size distribution of the composition has a surface weighted mean diameter D [3,2] of 10 μm or less.

2. The composition according to paragraph 1, wherein the composition does not include a hydrocolloid.

3. The composition according to either paragraphs 1 or 2, wherein the composition does not include an emulsifier other than beet pectin.

4. The composition according to any of paragraphs 1 through 3, where the composition does not include a buffering agent.

5. The composition according to any of paragraphs 1 through 4, wherein the vegetable base comprises legumes, nuts, seeds, cereals and combination thereof.

6. The composition according to any of paragraphs 1 through 5, wherein the legume comprises a pulse.

7. The composition according to paragraph 6, wherein the pulse comprises split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, fava, faba, soy and/or lupin.

8. The composition according to paragraph 5, wherein the nut comprises almonds, cashews, pecans, macadamias, hazelnuts, pistachio, walnuts and combinations thereof.

9. The composition according to paragraph 5, wherein the seeds comprise hemp, pumpkin, quinoa, sesame, tiger nut, flax, chia, sunflower, coconut and combinations thereof.

10. The composition according to paragraph 5, wherein the cereal comprises wheat, rye, spelt, barley, oat, millet, sorghum, rice, teff and combinations thereof.

11. The composition according to any of paragraphs 1 through 10, wherein the vegetable oil or vegetable fat comprises coconut oil, canola oil, soybean oil, sunflower oil, safflower oil, palm oil, palm kernel oil, olive oil, avocado oil and mixtures thereof.

12. The composition according to any of paragraphs 1 through 11, wherein the sugar beet pectin comprises approximately 8-20% protein by weight.

13. The composition according to any of paragraphs 1 through 11, wherein the sugar beet pectin comprises a molecular weight of not less than 50000 daltons.

14. The composition according to any of paragraphs 1 through 11, wherein a 2% solution of sugar beet pectin has a viscosity of about 1 to 300 cps.

15. The composition according to any of paragraphs 1 through 11, wherein the sugar beet pectin has a degree of acetate minimum of 10%.

16. The composition according to any of paragraphs 1 through 15, wherein the sugar beet pectin is present in about 0.001 percent to about 2 percent of the total weight of the composition.

17. The composition according to any of paragraphs 1 through 16, wherein the particle size of the emulsion has a surface weighted mean diameter of D [3,2] under 10 microns.

18. The composition of any of paragraphs 1 through 17, useful in plant based milks, butters, yogurts, beverage creamers, creams, sauces, salad dressings, plant based heavy creams, or plant based whipping creams.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

Particle size and particle size distribution of the samples were measured by using a particle size analyzer (Malvern Mastersizer 3000, Malvern, UK), equipped with a Hydro sample dispersion unit. To avoid multiple scattering effects, the measurements were conducted by adding the creamer dropwise into the sample dispersion unit until an obstruction value of between 5% and 10% was reached. Refractive indices of 1.450, 1.476, 1.449 and 1.33 for palm oil, soybean oil, coconut oil and water respectively.

The viscosity of the creamers was measured using a Kinexus Lab+Rheometer (Malvern, USA). A cup and bob geometry were used. Approximately 18 mL of creamer was placed in the sample cup and the viscosity measurements were done at 4° C. at varying shear rate (0.01 to 100 s⁻¹).

### Example 1: Preparation of a Shelf-Stable Liquid Creamer

Liquid plant-based creamers were prepared as below.

A liquid mixture was prepared by mixing together the ingredients as listed in Table 1 together with water up to 100% weight. The liquid mixture was homogenized using a two stage homogenization process (2000 psi for first stage and 500 psi for second stage), UHT heat treated (135° C. to 145° C. for 3-10 seconds) and homogenized in an aseptic homogeniser using a two stage homogenization process (2000 psi for first stage and 500 psi for second stage) a second time before being aseptically packaged. (SBP is sugar beet pectin.)

The supplier of SBP used herein was CP Kelco and the molecular weight of SBP used herein was at least 60 KDa and a 2% solution of sugar beet pectin has a viscosity of about 10 to 150 cps. Additional characteristics include: Degree of acetate is 14-26%, pH of 1% solution is between 3.0 to 4.0, and contains a minimum of 2 g of protein in 100 g of SBP.

TABLE 1

| % weight | Ingredient |
|---|---|
| 9.0 | Sunflower oil |
| 4.0 | Almond butter (ground almonds >90% dry matter + |
| | water)) |
| 0.25% | SBP |
| 25% | Sugar |

| | | | Dx (90) | | D [3, 2] |
|---|---|---|---|---|---|
| | Dx (10) | Dx (50) | (μm) or | D [4, 3] | (μm) or |
| | (μm) or | (μm) or | 90% of | (μm) or | surface |
| | 10% of the | 50% of the | the | Volume | weighted |
| Sample | particles | particles | particles | weighted | mean |
| Name | under | under | under | mean | diameter |
| Example 1 | 0.608 | 1.18 | 6.29 | 2.34 | 1.18 |

### Example 2: Preparation of a Shelf-Stable Liquid Creamer Containing Almond and Oat Using Sugar Beet Pectin

Liquid plant-based creamers were prepared as below.

A liquid mixture was prepared by mixing together the ingredients as listed in Table 2 together with water up to 100% weight. The liquid mixture was homogenized using a two stage homogenization process (2000 psi for first stage and 500 psi for second stage), UHT heat treated (135° C. to 145° C. for 3-10 seconds) and homogenized in an aseptic homogeniser using a two stage homogenization process (2000 psi for first stage and 500 psi for second stage) a second time before being aseptically packaged.

TABLE 2

| % weight | Ingredient |
|---|---|
| 9.0 | Coconut oil |
| 3.0 | Almond butter (ground almonds >90% dry matter + water) |
| 2.0 | Oat concentrate |
| 0.25% | SBP |
| 25% | Sugar |

| | Dx | Dx | Dx | | |
|---|---|---|---|---|---|
| | (10) | (50) | (90) | D [4, 3] | D [3, 2] |
| Example 2 | 0.624 | 1.58 | 14.2 | 5.49 | 1.4 |

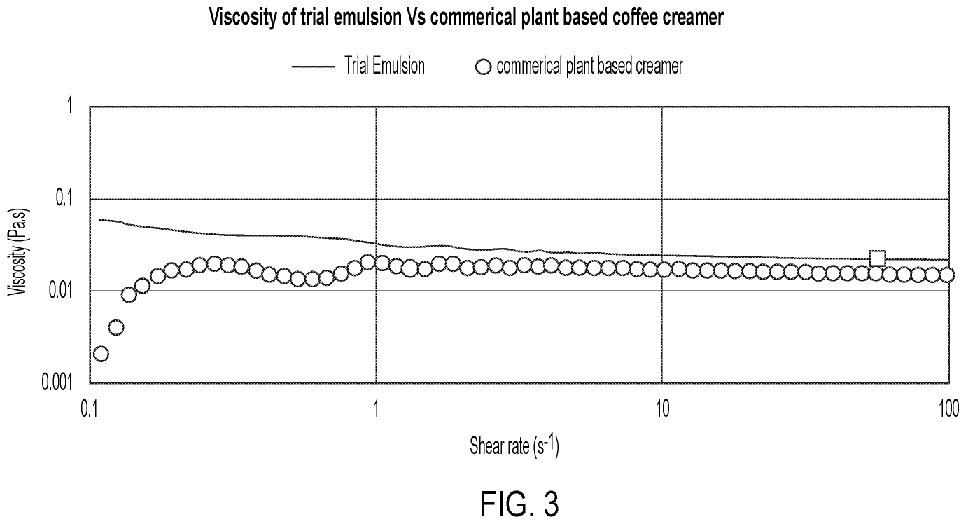

FIG. 3 provides viscosity data regarding Example 2.

### Example 3: Preparation of a Plant Based Milk Containing Almond Using Sugar Beet Pectin

A plant based milk was prepared with components noted in Table 3.

A liquid mixture was prepared by mixing together the ingredients as listed in Table 3 together with water up to 100% weight. The liquid mixture was mixed together, UHT heat treated (135° C. to 145° C. for 3-10 seconds) and homogenized in an aseptic homogeniser using a two stage homogenization process (2000 psi for first stage and 500 psi for second stage) a second time before being packaged.

TABLE 3

| % weight | Ingredient |
|---|---|
| 4.0 | Sunflower oil |
| 3.0 | Almond butter (ground almonds >90% dry matter + water) |
| 0.25% | SBP |
| 4% | Sugar |

The PSD and viscosity of Example 3 were similar to those of Example 2.

### Example 4: Preparation of a Plant Based Creamer Containing Almond Using Sugar Beet Pectin and Buffering Salts

A plant based creamer was prepared with components noted in Table 4.

A liquid mixture was prepared by mixing together the ingredients as listed in Table 4 together with water up to 100% weight. The liquid mixture was mixed together, UHT heat treated (135° C. to 145° C. for 3-10 seconds) and homogenized in an aseptic homogeniser using a two stage homogenization process (2000 psi for first stage and 500 psi for second stage) a second time before being packaged.

TABLE 4

| % weight | Ingredient |
|---|---|
| 8.0 | Sunflower oil |
| 3.0 | Almond butter (ground almonds >90% dry matter + water) |
| 0.25% | SBP |
| 0.5 | Potato protein |
| 0.05 | Baking soda |
| 0.05 | Potassium citrate |
| 4% | Sugar |

This creamer had similar particle size and viscosity like Example 3. However when the creamer was added to coffee, it showed feathering and instability.

It should be noted that either faba or pea protein can replace potato protein.

### Example 5: Preparation of a Plant Based Creamer Containing Almond Using Sugar Beet Pectin, Vegetable Protein and Buffering Salts

A plant based creamer was prepared with components noted in Table 5.

A liquid mixture was prepared by mixing together the ingredients as listed in Table 5 together with water up to 100% weight. The liquid mixture was mixed together, UHT heat treated (135° C. to 145° C. for 3-10 seconds) and homogenized in an aseptic homogeniser using a two stage homogenization process (2000 psi for first stage and 500 psi for second stage) a second time before being packaged.

TABLE 5

| % weight | Ingredient |
|---|---|
| 8.0 | Sunflower oil |
| 3.0 | Almond butter (ground almonds >90% dry matter + water) |
| 0.25% | SBP |
| 0.5 | Potato protein |
| 0.07 | Baking soda |
| 0.13 | Potassium citrate |
| 4% | Sugar |

An overall reduction in PSD is noticed in comparison to Example 4 with similar rheological data.

| | Dx | Dx | Dx | | |
|---|---|---|---|---|---|
| | (10) | (50) | (90) | D [4, 3] | D [3, 2] |
| Example 4 | 0.554 | 0.977 | 1.84 | 1.1 | 0.903 |

It should be noted that either faba or pea protein can replace potato protein.

When added to coffee, this did not feather and obtained a stable creamer, with similar whitening properties like a commercial creamer.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

1. A composition comprising:
a) 40-95% w/w water;
b) 0.001-40% w/w of a vegetable oil or vegetable fat;
c) 0.001-2% sugar beet pectin; and at least one or more of:
d) 00.01-2% plant proteins;
e) 0-7% w/w a nut base composition;
f) 0-35% w/w a sweeting agent;
g) 0.0001%-5% w/w a buffering agent; and/or
h) 0.0001% to 5% w/w a flavor modification agent, wherein the particle size particle size distribution of the composition has a surface weighted mean diameter D [3,2] of 10 μm or less.

2. The composition according to claim 1, wherein the composition does not include a hydrocolloid.

3. The composition according to claim 1, wherein the composition does not include an additional emulsifier other than beet pectin.

4. The composition according to claim 1, where the composition does not include a buffering agent.

5. The composition according to claim 1, wherein the vegetable base comprises legumes, nuts, seeds, cereals and combination thereof.

6. The composition according to claim 5, wherein the legume comprises a pulse.

7. The composition according to claim 6, wherein the pulse comprises split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, fava, faba, soy and/or lupin.

8. The composition according to claim 5, wherein the nut comprises almonds, cashews, pecans, macadamias, hazelnuts, pistachio, walnuts and combinations thereof.

9. The composition according to claim 5, wherein the seeds comprise hemp, pumpkin, quinoa, sesame, tiger nut, flax, chia, sunflower, coconut and combinations thereof.

10. The composition according to claim 5, wherein the cereal comprises wheat, rye, spelt, barley, oat, millet, sorghum, rice, teff and combinations thereof.

11. The composition according to claim 1, wherein the vegetable oil or vegetable fat comprises coconut oil, canola oil, soybean oil, sunflower oil, safflower oil, palm oil, palm kernel oil, olive oil, avocado oil and mixtures thereof.

12. The composition according to claim 1, wherein the sugar beet pectin comprises approximately 8-20% protein by weight.

13. The composition according to claim 1, wherein the sugar beet pectin comprises a molecular weight of not less than 50000 daltons.

14. The composition according to claim 1, wherein a 2% solution of sugar beet pectin has a viscosity of about 1 to 300 cps.

15. The composition according to claim 1, wherein the sugar beet pectin has a degree of acetate minimum of 10%.

16. The composition according to claim 1, wherein the sugar beet pectin is present in about 0.001 percent to about 2 percent of the total weight of the composition.

17. The composition according to claim 1, wherein the particle size of the emulsion has a surface weighted mean diameter of D [3,2] under 10 microns.

18. The composition according to claim 1, wherein the composition is included in a product comprising plant based milks, butters, yogurts, beverage creamers, cream, sauces, salad dressings, plant based heavy cream, or plant based whipping creams.
